(19) United States
(12) Patent Application Publication
(10) Pub. No.: US 2022/0049537 A1
(43) Pub. Date: Feb. 17, 2022

(54) APPARATUS AND METHOD FOR CONTROLLING WINDOW

(71) Applicants: Hyundai Motor Company, Seoul (KR); Kia Corporation, Seoul (KR)

(72) Inventor: Hee Tae YANG, Yongin-si (KR)

(73) Assignees: Hyundai Motor Company, Seoul (KR); Kia Corporation, Seoul (KR)

(21) Appl. No.: 17/400,381

(22) Filed: Aug. 12, 2021

(30) Foreign Application Priority Data
Aug. 12, 2020 (KR) 10-2020-0101177

(51) Int. Cl. E05F 15/41; E05F 15/695; E05F 15/70

(52) U.S. Cl. CPC E05F 15/41; E05Y 2900/55; E05F 15/70; E05F 15/695

(57) ABSTRACT

A window control apparatus and a window control method thereof which can prevent erroneous operation of a window at the time of simultaneously operating a plurality of windows, may include a sensing unit of sensing a position of a window, a driving unit of driving the window, and a controller configured to control the driving unit to perform a window up operation upon reception of a window up operation command, to check whether a current position of the window has reached the upper end portion of a window frame, to control the driving unit to reversely drive the window when the window has not reached the upper end portion of the window frame, to control the driving unit to stop the window up operation and perform a window restraining operation if other windows stop when the window has reached the upper end portion.

### CROSS-REFERENCE TO RELATED APPLICATION

The present application claims priority to Korean Patent Application No. 10-2020-0101177, filed on Aug. 12, 2020, the entire contents of which is incorporated herein for all purposes by this reference.

### BACKGROUND OF THE INVENTION

### Field of the Invention

The present invention relates to a window control apparatus for vehicles, and more specifically, to a window control apparatus and a window control method thereof which can prevent erroneous operation of a window at the time of simultaneously operating a plurality of windows.

### Description of Related Art

As application of a one-touch function for automatic up/down of power windows to vehicles is generalized, the number of a variety of convenience functions for window control is increasing.

Power windows of vehicles can be remotely open/closed using a vehicle remote controller or controlled through an audio command automatically closed in response to air quality at the time of entering a tunnel.

When a window is automatically closed, a part of the body of a passenger may be caught between the window and the window frame and thus damaged. Accordingly, a safety function of detecting a part of the body caught in a window and reversely driving the window is regulated by regulations in most countries.

For a conventional safety function, a method of indirectly detecting an object caught in a window by a controller in a window motor using a Hall sensor may be used. When the speed of the motor rotating at a constant speed sharply decreases, an object is determined to be caught in a window and the window may be reversely driven.

Furthermore, since a direct detection method of directly detecting an object caught in a window through a contact sensor is expensive, the indirect detection method using a motor speed is widely used.

However, the indirect detection method using a motor speed may cause a problem of erroneously determining that an object is caught even when the motor speed decreases due to voltage drop in a vehicle although the object is not actually caught.

As convenience functions of simultaneously closing a plurality of windows according to remote control, audio command control, tunnel entrance control, air-conditioning function control, or the like have recently been applied to vehicles, cases in which an object caught in a window is erroneously detected due to voltage drop in a vehicle caused by restraint of another window during window operation and thus the window is erroneously operated frequently occur.

Accordingly, there is demand for development of a window control apparatus capable of preventing a window from being erroneously operated due to erroneous detection of an object caught between the window and the window frame at the time of simultaneously operating a plurality of windows.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a window control apparatus and a window control method thereof which can prevent erroneous operation of a window due to erroneous detection of an object caught between the window and the window frame at the time of simultaneously operating a plurality of windows by stopping a window up operation when the window has reached the upper end portion of a window frame and performing an operation of restraining the window when another window stops.

It will be appreciated by persons skilled in the art that the objects that could be achieved with the present invention are not limited to what has been particularly described hereinabove and the above and other objects that the present invention could achieve will be more clearly understood from the following detailed description.

To achieve these objects and other advantages and in accordance with the present invention, as embodied and broadly described herein, a window control apparatus may include a sensing unit configured to detect a position of a window, a driving unit configured to drive the window, and a controller configured to control the driving unit on the basis of the sensed window position, wherein the controller is configured to control the driving unit to perform a window up operation for the window upon reception of a window up operation command, checks whether a current position of the window has reached the upper end portion of a window frame, detects an object caught between the window and the window frame and controls the driving unit to reversely drive the window when the window has not reached the upper end portion of the window frame, and controls the driving unit to stop the window up operation and perform a window restraining operation if another window stops when the window has reached the upper end portion.

In another aspect of the present invention, a window control method of a window control apparatus including a controller configured to control a driving unit for driving windows, by the controller, may include receiving a window up operation command, controlling the driving unit to perform a window up operation for a window, controlling the driving unit to perform a window up operation, checking whether a current position of the window has reached an upper end portion of a window frame, stopping the window up operation when the window has reached the upper end portion of the window frame; checking whether another window stops, determining a window restraining order when the other window stops, and controlling the driving unit to restrain the window according to the window restraining order.

In another aspect of the present invention, a computer-readable recording medium storing a program for executing a window control method of a window control apparatus may perform the process of the above-described window control method of a window control apparatus.

In another aspect of the present invention, a vehicle may include an integrated body control unit configured to transmit a window up operation command, and a window control apparatus configured to control an operation of a window in a response to the window up operation command wherein the window control apparatus may be configured to control a window to perform a window up operation upon reception of the window up operation command, to check whether a current position of the window has reached an upper end portion of a window frame, to detect an object caught between the window and the window frame and control the window to be reversely driven when the window has not reached the upper end portion of the window frame, and to stop the window up operation when the window has reached the upper end portion and restrain the window when another window stops.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a vehicle including a window control apparatus according to various exemplary embodiments of the present invention.

FIG. 2 is a block diagram illustrating the window control apparatus according to various exemplary embodiments of the present invention.

FIG. 3 is a diagram showing a sensor waveform and a current waveform according to an object caught in a window.

FIG. 4 is a diagram showing a motor speed waveform according to an object caught in a window.

FIG. 5 is a flowchart illustrating a window control method of a window control apparatus according to various exemplary embodiments of the present invention.

It may be understood that the appended drawings are not necessarily to scale, presenting a somewhat simplified representation of various features illustrative of the basic principles of the present invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

The detailed description of the exemplary embodiments of the present invention will be provided to enable those skilled in the art to implement and practice the present invention with reference to the appended drawings. However, the present invention may be implemented in various different forms and is not limited to exemplary embodiments described herein. Furthermore, portions that are not related to description will be omitted for clear description in the drawings, and the same reference numbers will be used throughout the present specification to refer to the same or like portions.

Throughout the specification, when it is said that some part “includes” a specific element, this means that the part may further include other elements, not excluding the same, unless mentioned otherwise. Furthermore, the term “-er(or)”, “module”, “portion” or “part” is used to signify a unit for performing at least one function or operation, and the unit may be realized as hardware, software, or a combination thereof.

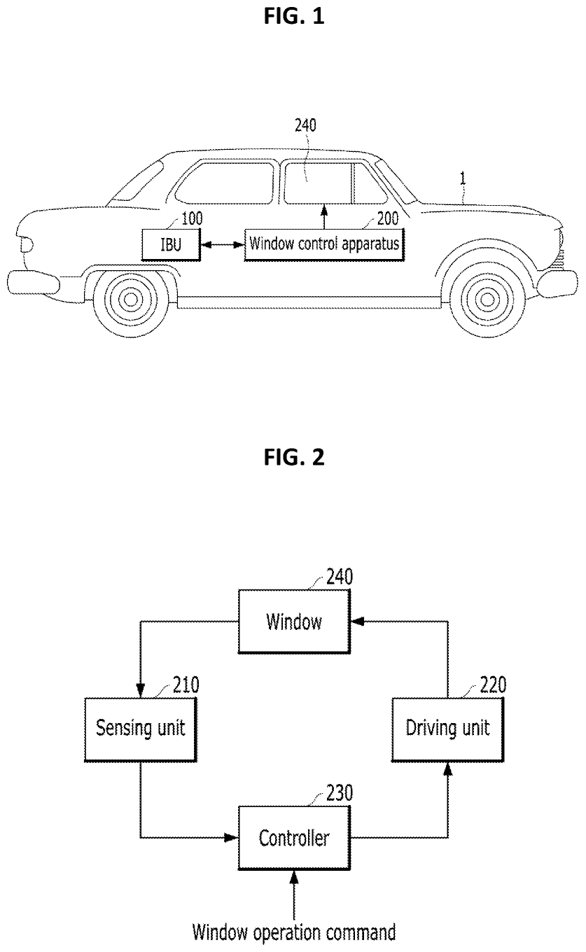

Hereinafter, a window control apparatus and a window control method thereof applicable to exemplary embodiments of the present invention will be described in detail with reference to FIG. 1 to FIG. 5.

FIG. 1 is a diagram illustrating a vehicle including a window control apparatus according to various exemplary embodiments of the present invention.

As illustrated in FIG. 1, a vehicle 1 of the present invention may include an integrated body control unit (IBU) 100 that transmits a window up operation command, and a window control apparatus 200 that controls operation of a window 240 in a response to the window up operation command.

The IBU 100 may transmit the window up operation command to the window control apparatus 200 through Local Interconnect Network (LIN) communication when remote control, audio command control, tunnel entrance control, or air-conditioning function control are executed.

Furthermore, the window control apparatus 200 may control the window 240 to perform a window up operation upon reception of the window up operation command, check whether the current position of the window 240 has reached the upper end portion of the corresponding window frame, detect an object caught between the window and the window frame when the current state of the window 240 has not reached the upper end portion and control the window to be reversely driven, stop the window up operation of the window 240 when the window 240 has reached the upper end portion of the window frame, and control the window 240 to be restrained when another window stops.

Here, the window control apparatus 200 may receive the window up operation command from the IBU 100 through LIN communication.

Furthermore, when the window control apparatus 200 controls the window 240 to perform the window up operation, the window control apparatus 200 may transmit window state information in which current position information of the window 240 represents an open state and operating state information of the window 240 represents an operating state to the IBU 100 through LIN communication.

Furthermore, when the window control apparatus 200 controls the window to be reversely driven, the window control apparatus 200 may check whether an object is caught between the window and the window frame when the window 240 has not reached the upper end portion of the window frame, control the window to be reversely driven upon detection of an object caught between the window and the window frame, and control the window 240 to execute the window up operation when the controller concludes that no object is caught between the window and the window frame.

For example, the window control apparatus 200 may control the window 240 to be reversely driven within a range of about 200 to 400 mm, but the present invention is not limited thereto.

Furthermore, when the window 240 is reversely driven, the window control apparatus 200 may transmit window state information in which current position information of the window 240 represents an open state and operating state information of the window 240 represents a stop state to the IBU 100 through LIN communication.

Furthermore, when the window control apparatus 200 controls the window 240 to be restrained, the window control apparatus 200 may control the window 240 to stop the window up operation when the window 240 has reached the upper end portion of the window frame, check whether another window stops, determine a window restraining order when the other window stops, and control the window 240 to be restrained according to the window restraining order.

Here, when the window control apparatus 200 checks whether another window stops, if a plurality of other windows is present in the vehicle, the window control apparatus 200 may monitor all of the other windows and check whether all of the other windows stop.

Furthermore, the window control apparatus 200 may determine the window restraining order on the basis of a LIN communication cycle if all of the other windows stop.

For example, in determination of the window restraining order, the window control apparatus 200 may determine a restraining order of a front left window, a front right window, a rear left window, and a rear right window if communication order of the LIN communication cycle is the order of the IBU, the front left window, the front right window, the rear left window, and the rear right window and a communication time interval is about 5 to 15 ms, but the present invention is not limited thereto.

Furthermore, when the window control apparatus 200 stops the window up operation of the window 240, the window control apparatus 200 may transmit window state information in which current position information of the window 240 represents a closed state and operating state information of the window 240 represents a stop state to the IBU 100 through LIN communication when the window 240 stops the window up operation.

Furthermore, when the window control apparatus 200 controls the window to be restrained, the window control apparatus 200 may transmit window state information in which current position information of the window represents a closed state and operating state information of the window represents an operating state to the IBU 100 through LIN communication before the operation of restraining the window 240 is performed.

Furthermore, when the window control apparatus 200 controls the window to be restrained, the window control apparatus 200 may transmit window state information in which current position information of the window represents a closed state and operating state information of the window represents a stop state to the IBU 100 through LIN communication upon completion of the operation of restraining the window 240.

For example, the window control apparatus 200 may control the window 240 to be restrained for about 100 to 300 ms.

In the present manner, the present invention can prevent an erroneous reversing operation of a window caused by erroneous detection of an object caught between the window and the window frame at the time of simultaneously operating a plurality of windows by stopping the window up operation when the window has reached the upper end portion of the window frame and performing the operation of restraining the window when another window stops.

Furthermore, the present invention can solve an erroneous operation problem caused by window restraint without window wind noise and deterioration in water tightness by controlling restraining timing through controller logic change while maintaining the existing system.

FIG. 2 is a block diagram illustrating the window control apparatus according to various exemplary embodiments of the present invention.

As illustrated in FIG. 2, the window control apparatus 200 may include a sensing unit 210 that detects a position of the window 240, a driving unit 220 that drives the window 240, and a controller 230 that controls the driving unit 220 on the basis of a detected window position.

Here, the sensing unit 210 may include a Hall sensor for sensing a rotation rate of a motor, but the present invention is not limited thereto.

Furthermore, the driving unit 220 may include a motor configured for performing a window up operation or a window down operation for the window 240, but the present invention is not limited thereto.

The controller 230 may control the driving unit 220 to perform a window up operation for the window 240 upon reception of a window up operation command, check whether the current position of the window 240 has reached the upper end portion of the window frame, detect an object caught between the window and the window frame when the window 240 has not reached the upper end portion and control the driving unit 220 to reversely drive the window, and control the driving unit 220 to stop the window up operation for the window 240 when the window 240 has reached the upper end portion and to restrain the window 240 when another window stops.

Here, the controller 230 may receive the window up operation command from the IBU 100 through LIN communication.

Furthermore, when the controller 230 controls the driving unit 220 to perform the window up operation, the controller 230 may transmit window state information including current position information and operating state information of the window 240 to the IBU 100 through LIN communication upon execution of the window up operation.

For example, the controller 230 may transmit window state information in which current position information of the window 240 represents an open state and operating state information of the window 240 represents an operating state.

Accordingly, the controller 230 may check whether the current position of the window 240 has reached the upper end portion of the window frame on the basis of a sensing signal received from the sensing unit 210.

Accordingly, when controller 230 controls the driving unit 220 to reversely drive the window 240, the controller 230 may check whether an object is caught between the window and the window frame when the window 240 has not reached the upper end portion of the window frame, control the driving unit 220 to reversely drive the window 240 when there is an object caught between the window and the window frame, and control the driving unit 220 to perform the window up operation for the window 240 when there is no object caught between the window and the window frame.

Furthermore, the controller 230 may control the driving unit 220 to reversely drive the window 240 within a range of about 200 to 400 mm.

Furthermore, when the controller 230 controls the driving unit 220 to reversely drive the window 240, the controller 230 may transmit window state information including current position information and operating state information of the window 240 to the IBU 100 through LIN communication upon execution of the operation of reversely driving the window 240.

For example, the controller 230 may transmit window state information in which current position information of the window 240 represents an open state and operating state information of the window 240 represents a stop state.

Furthermore, when the controller 230 controls the driving unit 220 to restrain the window 240, the controller 230 may control the driving unit 220 to stop the window up operation for the window 240 when the window 240 has reached the upper end portion of the window frame, check whether another window stops, determine a window restraining order when the other window stops, and control the driving unit 220 to restrain the window 240 according to the window restraining order.

Here, when the controller 230 checks whether another window stops, if a plurality of other windows is present in the vehicle, the controller 230 may monitor all of the other windows and check whether all of the other windows stop.

Furthermore, the controller 230 may determine the window restraining order on the basis of a LIN communication cycle if all the other windows stop.

Here, the controller 230 may check a communication order and communication time of the LIN communication cycle and determine the window restraining order on the basis of the checked communication order and communication time.

For example, in determination of the window restraining order, the controller 230 may determine a restraining order of a front left window, a front right window, a rear left window, and a rear right window if the communication order of the LIN communication cycle is the order of the IBU, the front left window, the front right window, the rear left window, and the rear right window and a communication time interval is about 5 to 15 ms.

Accordingly, when the controller 230 controls the driving unit 220 to restrain the window 240, the controller 230 may check whether the communication cycle is executed on a basis of the window restraining order and control the driving unit 220 to restrain the window 240 corresponding to the window restraining order when the controller concludes that the LIN communication cycle is executed.

The controller 230 may transmit window state information including current position information and operating state information of the window 240 to the IBU 100 through LIN communication when the window up operation of the window 240 stops.

For example, the controller 230 may transmit window state information in which current position information of the window 240 represents a closed state and operating state information of the window 240 represents a stop state.

Furthermore, when the controller 230 controls the driving unit 220 to restrain the window 240, the controller 230 may transmit window state information including current position information and operating state information of the window 240 to the IBU 100 through LIN communication before the operation of restraining the window 240 is performed.

For example, the controller 230 may transmit window state information in which current position information of the window 240 represents a closed state and operating state information of the window 240 represents an operating state.

Furthermore, when the controller 230 controls the driving unit 220 to restrain the window 240, the controller 230 may control the driving unit 220 to restrain the window 240 for about 100 to 300 ms.

Thereafter, when the controller 230 controls the driving unit 220 to restrain the window 240, the controller 230 may transmit window state information including current position information and operating state information of the window 240 to the IBU 100 through LIN communication upon completion of the operation of restraining the window 240.

For example, the controller 230 may transmit window state information in which current position information of the window 240 represents a closed state and operating state information of the window 240 represents a stop state.

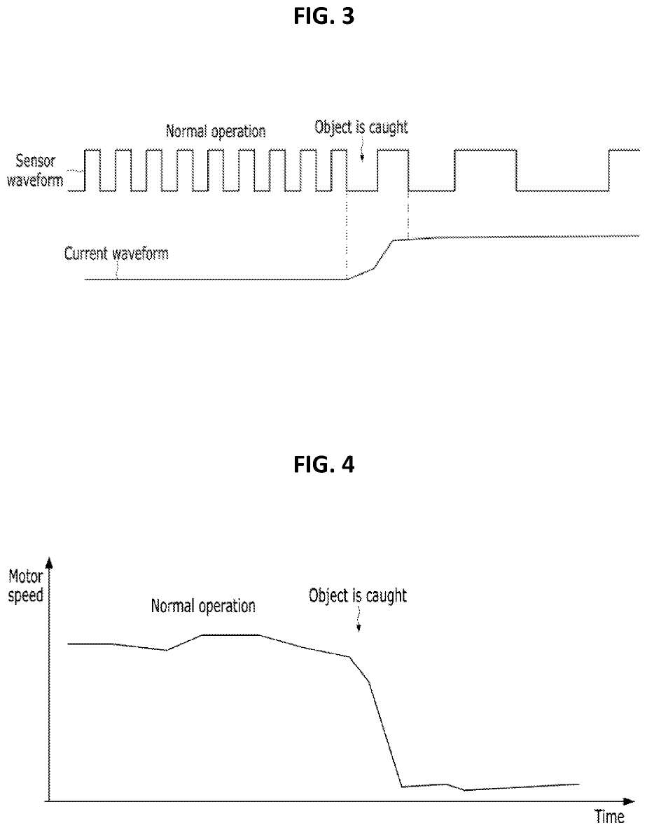

FIG. 3 is a diagram showing a sensor waveform and a current waveform according to an object caught in a window and FIG. 4 is a diagram showing a motor speed waveform according to an object caught in a window.

As illustrated in FIG. 3 and FIG. 4, the window control apparatus of the present invention may use a Hall sensor for sensing a rotation rate of a motor as the sensing unit for sensing a position of a window and use a motor configured for performing a window up operation or a window down operation as the driving unit for driving a window.

In the instant case, the present invention may monitor the rate of rotation of the motor through the Hall sensor and ascertain a current position and an operating speed of a window through the rate of rotation of the motor.

As shown in FIG. 3, the motor rotates at a constant speed and a Hall sensor cycle is maintained uniform when a window is in a normal operating state, but the motor is restrained and the Hall sensor cycle abruptly increases when an object is caught between the window and the window frame.

Accordingly, the controller may detect an object caught between the window and the window frame by comparing a previous rotation speed of the motor with the current rotating speed.

Furthermore, since the controller can ascertain a current position of the window by counting the number of Hall pulses, the controller can check whether the window has reached the upper end portion of the window frame or is at a middle position and perform an operation of reversely driving the window upon determining that an object is caught between the window and the window frame during operation.

If the controller determines that the window has reached the upper end portion of the window frame, the controller may monitor operating states of other windows and restrain the windows for a predetermined time period (about 200 ms) through additional driving such that wind or water is not introduced into the vehicle when all the windows stop.

Furthermore, as shown in FIG. 4, the motor rotates at a constant speed and thus the motor speed is maintained uniform when a window is in a normal operating state, but the motor is restrained and thus the motor speed abruptly decreases when an object is caught between the window and the window frame.

Accordingly, the controller may detect an object caught between the window and the window frame by comparing a previous rotation speed of the motor with the current rotating speed.

In the present manner, the present invention may check whether a window has reached the upper end portion of the window frame or check whether an object is caught between the window and the window frame, control an operation of reversely driving the window to be performed when there is an object caught in a window, and control a window up operation to be performed when there is no object caught between the window and the window frame.

Furthermore, the present invention may control the window up operation to be performed when the window has reached the upper end portion and control the operation of restraining the window to be performed when other windows stop.

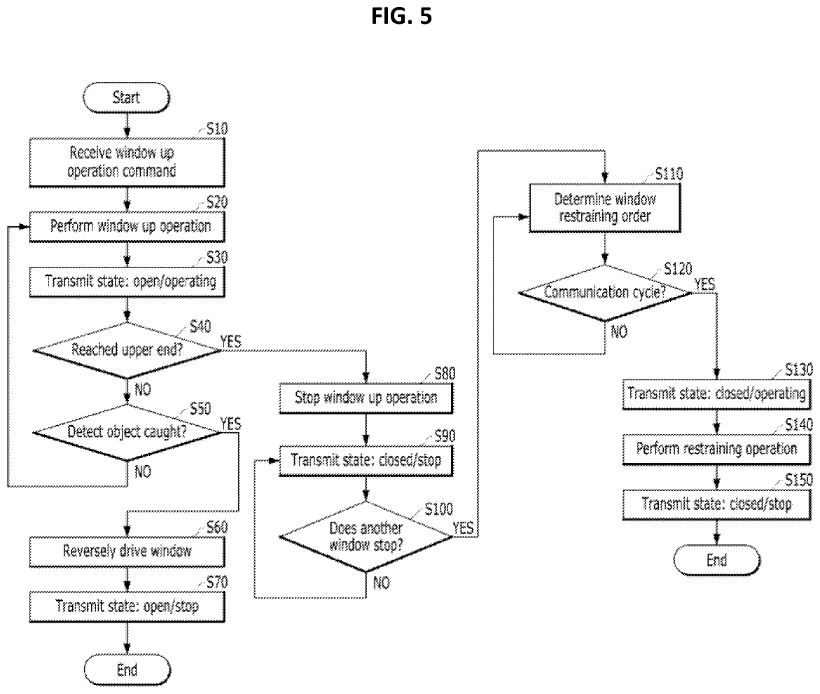

FIG. 5 is a flowchart illustrating a window control method of the window control apparatus according to various exemplary embodiments of the present invention.

As illustrated in FIG. 5, the present invention may receive a window up operation command from an IBU through LIN communication (S10).

Thereafter, the present invention may control a window to move up (S20).

Accordingly, the present invention may transmit window state information representing that current position information of the window is an open state and operating state information of the window is an operating state when the window up operation is performed (S30).

The present invention may check whether a current position of the window has reached the upper end portion of the window frame (S40).

Thereafter, the present invention may check whether an object is caught between the window and the window frame if the window has not reached the upper end portion (S50).

Next, the present invention may control the window to move up when there is no object caught between the window and the window frame and control the window to be reversely driven when there is an object caught between the window and the window frame (S60).

When the window is controlled to be reversely driven, the present invention may transmit window state information in which current position information of the window represents an open state and operating state information of the window represents a stop state (S70).

When the window has reached the upper end portion of the window frame, the present invention may stop the window up operation (S80).

Subsequently, the present invention may transmit window state information in which current position information of the window represents a closed state and operating state information of the window represents a stop state when the window up operation stops (S90).

Next, the present invention may check whether another window stops (S100).

Here, if a plurality of other windows is present in the vehicle, the present invention may monitor all the windows and check whether all the windows stop.

Furthermore, the present invention may determine a window restraining order if other windows stop (S110).

Here, if all the other windows stop, the present invention may determine a window restraining order on the basis of a LIN communication cycle.

Subsequently, the present invention may check whether the communication cycle is executed on a basis of the window restraining order (S120).

Accordingly, the present invention may transmit window state information in which current position information of the window represents a closed state and operating state information of the window represents an operating state when the communication cycle is executed (S130).

Furthermore, the present invention may control an operation of restraining the windows to be performed in the window restraining order (S140).

Here, the present invention may control the operation of restraining the windows to be performed for about 100 to 300 ms.

Subsequently, the present invention may transmit window state information in which current position information of the window represents a closed state and operating state information of the window represents a stop state when the operation of restraining the windows is completed (S150).

Meanwhile, the present invention may perform processes of the window control method of the window control apparatus as a computer-readable recording medium recording a program for executing the window control method of the window control apparatus.

As described above, the present invention can prevent an erroneous window operation caused by erroneous detection of an object caught in a window at the time of simultaneously operating a plurality of windows by stopping a window up operation when a window has reached the upper end portion of the window frame and performing an operation of restraining the window when other windows stop.

Furthermore, the present invention can solve an erroneous operation problem caused by window restraint without window wind noise and deterioration in water tightness by controlling restraining timing through controller logic change while maintaining the existing system.

The above-described present invention may be realized as computer-readable code in a medium in which a program is recorded. Computer-readable media include all kinds of recording devices in which data readable by computer systems is stored. Examples of computer-readable media include a hard disk drive (HDD), a solid state drive (SSD), a silicon disk drive (SDD), a ROM, a RAM, a CD-ROM, a magnetic tape, a floppy disk, an optical data storage device, etc.

Therefore, the above detailed description is therefore to be construed in all aspects as illustrative and not restrictive. The scope of the present invention should be determined by the appended claims and their legal equivalents, not by the above description, and all changes coming within the meaning and equivalency range of the appended claims are intended to be embraced therein.

The window control apparatus and the window control method thereof according to at least various exemplary embodiments of the present invention configured as above can prevent an erroneous window operation caused by erroneous detection of an object caught in a window at the time of simultaneously operating a plurality of windows by stopping a window up operation when a window reaches the upper end portion of the window frame and performing an operation of restraining the window when other windows are in a stop state.

Furthermore, the present invention can solve an erroneous operation problem caused by window restraint without window wind and deterioration in water tightness by controlling restraining timing through controller logic change while maintaining the existing system.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method disclosed in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet).

In various exemplary embodiments of the present invention, each operation described above may be performed by a control device, and the control device may be configured by multiple control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A window control apparatus comprising:
a sensing unit configured to detect a position of a window;
a driving unit configured to drive the window; and
a controller electrically connected to the sensing unit and the driving unit and configured to control the driving unit according to the detected position of the window,
wherein the controller is configured to control the driving unit to perform a window up operation for the window upon reception of a window up operation command, to control the driving unit to stop the window up operation when the controller determines that the window has reached an upper end portion of a window frame, and to control the driving unit to restrain the window when the controller determines that another window stops.

2. The window control apparatus of claim 1,
wherein the driving unit includes a motor, and
wherein the sensing unit includes a Hall sensor configured to detect a rotation rate of the motor.

3. The window control apparatus of claim 1, wherein the driving unit includes a motor configured to perform the window up operation or a window down operation of the window.

4. The window control apparatus of claim 1, wherein the controller is configured to receive the window up operation command from an integrated body control unit (IBU) through local interconnect network (LIN) communication.

5. The window control apparatus of claim 1, wherein the controller is configured to check whether a current position of the window has reached the upper end portion of the window frame, to determine whether an object is caught between the window and the window frame when the window has not reached the upper end portion of the window frame, and to control the driving unit to reversely drive the window when the controller concludes that the object is caught between the window and the window frame.

6. The window control apparatus of claim 5, wherein the controller is configured to check whether the current position of the window has reached the upper end portion of the window frame according to a sensing signal received from the sensing unit.

7. The window control apparatus of claim 5, wherein, when the controller controls the driving unit to reversely drive the window, the controller is configured to check whether the object is caught between the window and the window frame when the window has not reached the upper end portion of the window frame, to control the driving unit to reversely drive the window when the controller concludes that the object is caught between the window and the window frame, and to control the driving unit to perform the window up operation when the controller concludes that no object is caught between the window and the window frame.

8. The window control apparatus of claim 1, wherein, when the controller controls the driving unit to restrain the window, the controller is configured to control the driving unit to stop the window up operation when the window has reached the upper end portion of the window frame, to check whether another window stops, to determine a window restraining order when another window stops, and to control the driving unit to restrain the window according to the window restraining order.

9. The window control apparatus of claim 8,
wherein a plurality of windows including the window and another window is equipped in a vehicle, and
wherein, when the controller checks whether another window stops, the controller monitors remaining windows among the plurality of windows and checks whether the remaining windows stop.

10. The window control apparatus of claim 9, wherein the controller is configured to determine the window restraining order according to a local interconnect network (LIN) communication cycle when the remaining windows stop.

11. The window control apparatus of claim 8, wherein, when the controller controls the driving unit to restrain the window according to the window restraining order, the controller is configured to check whether a LIN communication cycle is executed on a basis of the window restraining order and to control the driving unit to restrain the window in the window restraining order when the controller concludes that the LIN communication cycle is executed.

12. The window control apparatus of claim 1, wherein, when the controller controls the driving unit to restrain the window, the controller is configured to control the driving unit to restrain the window for 100 to 300 ms.

13. A window control method of a window control apparatus including a driving unit and a controller configured to control the driving unit of driving windows, the window control method comprising:
receiving, by the controller, a window up operation command;
controlling, by the controller, the driving unit to perform a window up operation for a window;
checking, by the controller, whether a current position of the window has reached an upper end portion of a window frame;
stopping, by the controller, the window up operation when the controller determines that the window has reached the upper end portion of the window frame;
checking, by the controller, whether another window stops;
determining, by the controller, a window restraining order when the controller concludes that another window stops; and
controlling, by the controller, the driving unit to restrain the window according to the window restraining order.

14. The window control method of claim 13, wherein the receiving of the window up operation command includes receiving the window up operation command from an integrated body control unit (IBU) through Local Interconnect Network (LIN) communication.

15. The window control method of claim 13, wherein the checking of whether the current position of the window has reached the upper end portion includes:
checking, by the controller, whether an object is caught between the window and the window frame when the controller concludes that the window has not reached the upper end portion of the window frame; and
controlling, by the controller, the driving unit to reversely drive the window when the controller concludes that the object is caught between the window and the window frame.

16. The window control method of claim 13, wherein the checking of whether an object is caught between the window and the window frame includes controlling the driving unit to perform the window up operation when the controller concludes that no object is caught between the window and the window frame.

17. The window control method of claim 13,
wherein a plurality of windows including the window and another window is equipped in a vehicle, and
wherein the checking of whether another window stops includes, monitoring remaining windows among the plurality of windows and checking whether the remaining windows stop.

18. The window control method of claim 17, wherein the determining of the window restraining order includes determining the window restraining order according to a LIN communication cycle when the remaining windows stop.

19. The window control method of claim 13, wherein the controlling of the driving unit to restrain the window includes:
checking whether a LIN communication cycle is executed on a basis of the window restraining order; and
controlling the driving unit to restrain the window in the window restraining order when the controller concludes that the LIN communication cycle is executed.

20. A vehicle comprising:
an integrated body control unit configured to transmit a window up operation command; and
a window control apparatus including a controller and configured to control an operation of a window in a response to the window up operation command,
wherein the window control apparatus is configured to control the window to perform a window up operation upon reception of the window up operation command, to check whether a current position of the window has reached an upper end portion of a window frame, to determine whether an object is caught between the window and the window frame and control the window to be reversely driven when the window has not reached the upper end portion of the window frame, and to stop the window up operation when the window has reached the upper end portion and restrain the window when another window of the vehicle stops.
